(19) United States
(12) Patent Application Publication
(10) Pub. No.: US 2014/0360147 A1
(43) Pub. Date: Dec. 11, 2014

(54) FILTER ELEMENT WITH HIGH TEMPERATURE POLYMER RETAINING STRAPS AND METHOD OF MANUFACTURE

(71) Applicant: BHA Altair, LLC, Franklin, TN (US)

(72) Inventors: Cynthia Marie Polizzi, Delmar, NY (US); Vishal Bansal, Overland Park, KS (US); Bryan David Yetter, Kearney, MO (US)

(73) Assignee: BHA Altair, LLC, Franklin, TN (US)

(21) Appl. No.: 13/910,191

(22) Filed: Jun. 5, 2013

(51) Int. Cl. B01D 46/52

(52) U.S. Cl. CPC B01D 46/521
USPC 55/500; 264/257

(57) ABSTRACT

A filter element includes a filtration media formed into a tubular configuration. The filtration media includes a plurality of circumferentially spaced apart pleats. The filter element includes at least one retaining strap extending circumferentially around the filtration media to limit movement of the filtration media The at least one retaining strap has a ratio of flow direction tensile modulus to perpendicular direction tensile modulus of 1.5 or less. A method of fabricating a filter element is also provided.

### BACKGROUND OF THE INVENTION

1. Field of the Invention

The present invention relates generally to a filter element and, in particular, to a filter element having a retaining strap with a relatively low molecular orientation.

2. Discussion of the Prior Art

Filter elements are known and used in many different applications, including baghouses. Each baghouse may be provided with one or more filter elements for filtering dirty fluid (e.g., air) in various environments. The filter elements may include retaining straps to limit movement of a pleated filtration media. In the past, the retaining straps were applied to the filter elements through an extrusion process. However, this process of forming and applying the retaining straps often imparts a flow direction molecular orientation to the retaining straps. This molecular orientation is problematic because internal stresses can be locked into the cooled retaining strap, potentially leading to brittle fractures of the retaining strap and a shorter lifetime of the filter elements. Accordingly, there is a need and it would be beneficial to provide filter elements with retaining straps that have reduced/minimized molecular orientation so as to reduce the likelihood of fracture of the retaining straps and increase the longevity of the filter elements.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter element including a filtration media formed into a tubular configuration. The filtration media includes a plurality of circumferentially spaced apart pleats. The filter element includes at least one retaining strap extending circumferentially around the filtration media to limit movement of the filtration media. The at least one retaining strap has a ratio of flow direction tensile modulus to perpendicular direction tensile modulus of 1.5 or less.

In accordance with another aspect, the present invention provides a method of fabricating a filter element. The method includes the steps of providing a filtration media formed into a tubular configuration. The filtration media includes a plurality of circumferentially spaced apart pleats. The method includes the step of extruding a polymer extrudate through an extrusion flow channel. The method includes the step of applying the polymer extrudate to extend circumferentially around a portion of the filtration media to form a retaining strap that extends circumferentially around the filtration media to limit movement of the filtration media. The retaining strap has a ratio of flow direction tensile modulus to perpendicular direction tensile modulus of 1.5 or less.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a perspective view of an example baghouse having a plurality of filter elements having at least one aspect in accordance with the present invention;

FIG. 2 illustrates a perspective view of an example filter element including a plurality of example retaining straps in accordance at least one aspect of the present invention;

FIG. 3 illustrates a side elevation view of the filter element of FIG. 2;

FIG. 4 illustrates a cross-sectional view of the filter element of FIG. 3 taken along line 4-4 of FIG. 3;

FIG. 5 illustrates a view similar to FIG. 4 of a second example filter element in accordance at least one aspect of the present invention;

FIG. 6 illustrates a side elevation view of an example application apparatus applying a polymer extrudate to the filter element in accordance at least one aspect of the present invention; and

FIG. 7 illustrates a plan view of the application apparatus of FIG. 6 applying the polymer extrudate to the filter element.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

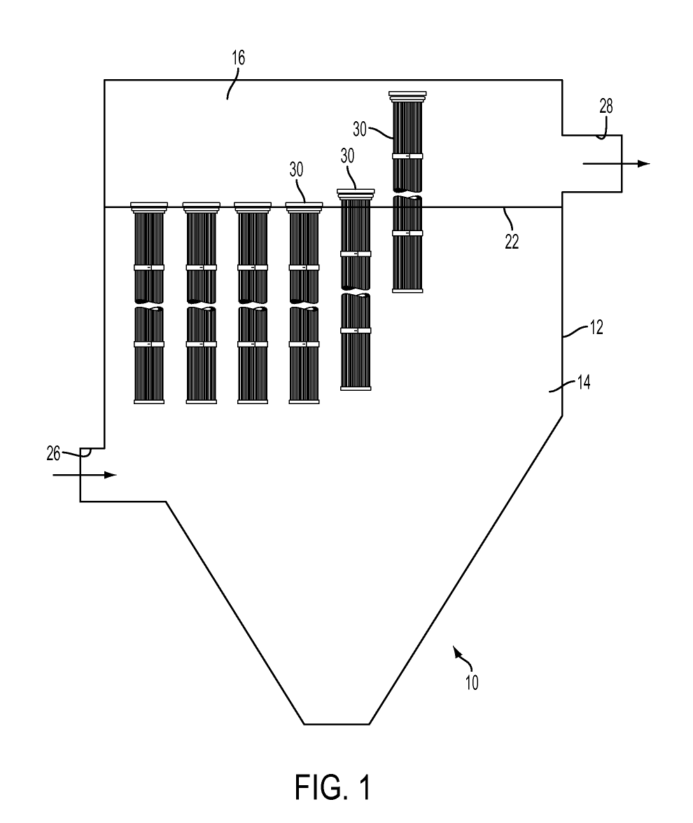

FIG. 1 schematically illustrates an example interior of a baghouse 10 as an environment within which the present invention may be utilized. It is to be appreciated that FIG. 1 merely illustrates one example of the possible structure/configuration of the baghouse 10, and that other examples are contemplated. In general, the baghouse 10 can be used for filtering and/or cleaning fluid (e.g., air, gases) that passes through the baghouse 10. The baghouse 10 can be used in any number of different environments that have a need for filtering/cleaning fluid (e.g., air, gases). Herein, the fluid to be filtered/cleaned is referred to simply as air, but with an understanding that the term air is to be broadly construed, such as including various gases, exhaust gases and the like).

The baghouse 10 may be defined by an enclosed housing 12. The housing 12 includes any number of sizes, shapes, and configurations, and is not specifically limited to the configuration illustrated in FIG. 1. The housing 12 can include two sections, a dirty air plenum 14 and a clean air plenum 16. The dirty air plenum 14 and the clean air plenum 16 may be placed in fluid communication with each other and separated by a tube sheet 22. The tube sheet 22 can include, for example, wall(s), divider(s), separating structure(s) or the like. The dirty air plenum 14 can be in fluid communication with a dirty air inlet port 26 allowing unfiltered air to enter the baghouse 10 through the dirty air inlet port 26. The clean air plenum 16 can be in fluid communication with a clean air outlet port 28 allowing filtered air to exit the baghouse 10 through the clean air outlet port 28.

The dirty air plenum 14 and the clean air plenum 16 may be arranged in fluid communication via one or more circular openings formed in the tube sheet 22. Each opening may be sized to accept and hold a filter element 30. The tube sheet 22 can limit and/or prevent the passage of air through the tube sheet 22. In an example, air may pass from the dirty air plenum 14 to the clean air plenum 16 through the filter elements 30. It is to be appreciated that the baghouse 10 may be varied and that the presented example is not to be taken as a limitation.

In the illustrated example of FIG. 1, the baghouse 10 includes six filter elements 30. However, the baghouse 10 is not so limited, and in other examples, may include any number (i.e., one or more) of filter elements 30. The filter elements 30 are generally elongate and may be arranged parallel (e.g., axes of elongation) to each other in a substantially vertical manner. In other examples, however, the filter elements 30 are not limited to the illustrated orientation (e.g., substantially vertical), and could be oriented at any number of angles, such as in a substantially horizontal manner, or the like.

The filter elements 30 are capable of filtering air to remove a variety of dry elements. For instance, the filter elements 30 may be used, but are not so limited, to filter hot gas(es) with temperatures up to and/or exceeding 500° F. (260° C.). In one example, the filter elements 30 may be used in environments having a temperature range of between approximately 375° F. to 500° F. (190° C. to 260° C.). In another example, the filter elements 30 may be used in environments having a temperature range of between approximately 400° F. to 500° F. (204° C. to 260° C.). In addition, the filter elements 30 may be used in applications at the stated temperatures in environments that may have gas streams and/or have dust which are acidic or alkaline. These environments can include, for example, a furnace environment (e.g., coal-fired furnace) having a flue gas stream.

The filter elements 30 can be used in any number of applications that include particulate removal from a fluid stream. In one example, the filter elements 30 can include a “pulse pleat” type of filter element that can be periodically subjected to reverse, pulsed cleaning fluid (e.g., clean air). The pulsed cleaning fluid can flow in an opposite direction to the direction that the particulate-laden fluid stream flows, such as from the clean air outlet port 28 towards the dirty air inlet port 26. In an example, the pulsed cleaning fluid is compressed, high-pressure, substantially particulate-free air. In other examples, the pulsed cleaning fluid can include any type of fluid that facilitates operation of the filter elements 30.

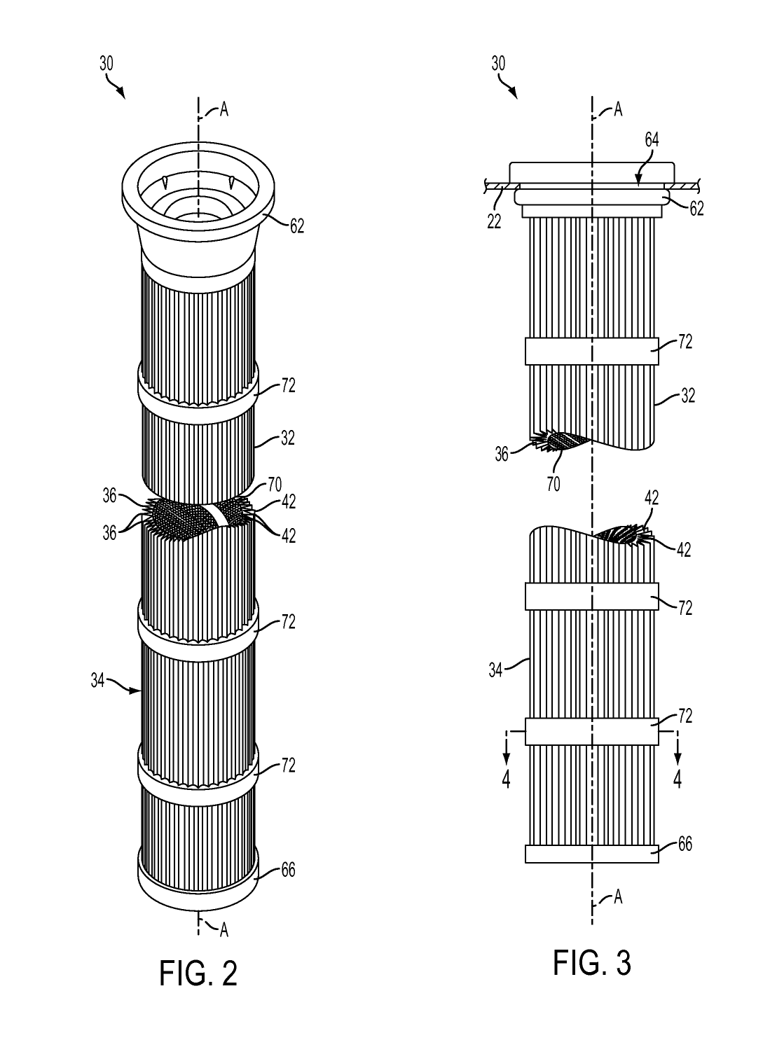

Turning now to FIG. 2, an example of the filter element 30 is illustrated. It is to be appreciated that while only one filter element 30 is illustrated in FIG. 2, the remaining, non-shown filter elements 30 can be similar or identical in size, shape, and construction as the filter element 30 of FIG. 2. Further, the filter element 30 is illustrated separate from the baghouse 10 for ease of illustration and to more clearly illustrate the structure of the filter element 30. In operation, however, the filter element 30 can be arranged in a similar manner as described above with respect to FIG. 1. The filter element 30 shown in FIGS. 2 and 3 is illustrated in broken form to signify that the filter element 30 could be longer/shorter in length than as illustrated.

The filter element 30 can include a filtration media 32. The filtration media 32 can be formed into a tubular configuration that is generally cylindrical. In this example, the filtration media 32 extends around a longitudinal central axis A. The filtration media 32 can include any number of materials that are capable of filtering a fluid stream. For instance, in an example, the filtration media 32 can include a polytetrafluoroethylene (PTFE) media substrate. Of course, the filtration media 32 is not limited to this material, and could include other materials that perform a filtration function.

The filtration media 32 includes a plurality of pleats 36. The pleats 36 are elongated parallel to the center axis A and extend in a zig-zag pattern toward and away from the center axis A. The pleats 36 are circumferentially spaced apart about a periphery 34 of the filter element 30. Each pleat 36 includes a tip portion 42 formed at a radially outermost location from the center axis A.

Turning now to FIG. 3, a schematic side view of the filter element 30 is illustrated. The filter element 30 can include a mounting structure 62 disposed at a first axial end of the filter element 30. The mounting structure 62 can facilitate mounting and/or sealing of the filter element 30 at an opening 64 of the tube sheet 22. The opening 64 can allow for a flow of particulate laden fluid and pulse fluid streams through the filter element 30. An end cap 66 can be attached to the filter element 30 and disposed opposite the mounting structure 62. The end cap 66 can be generally non-permeable, such that the fluid stream will pass through the filtration media 32 and not the end cap.

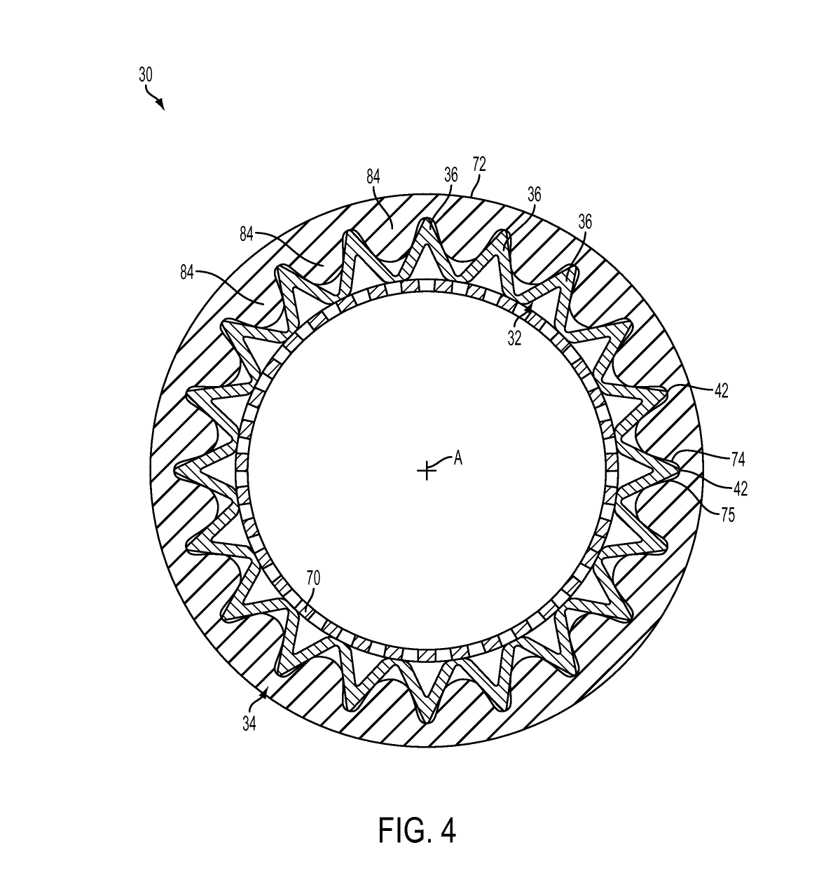

Turning now to FIG. 4, a sectional view along line 3-3 of the filter element 30 is illustrated. The filter element 30 can include a support 70 around which the filtration media 32 is oriented. The support 70 defines an elongated central passageway formed within the filter element 30. The support 70 can be made of a number of different metal materials, such as steel, titanium, or the like, and may be sufficiently stiff/rigid to provide at least some support to the filtration media 32. In one example, the support 70 can limit/prevent radial inward and/or outward movement of the filtration media 32 with respect to the central axis A. The support 70 includes openings on its surface to allow for the passage of air/fluid stream therethrough. For instance, the support 70 can include a plurality of perforations, apertures, holes, etc. to allow air to pass from an exterior of the filter element 30 to an interior of the filter element 30.

The filter element 30 includes at least one retaining strap 72 to restrain the filtration media 32 and limit movement (e.g., axial, radial, circumferential, etc.) of the filtration media 32. The retaining strap(s) 72 can also limit/reduce the likelihood of adjacent pleats 36 from moving, collapsing, or otherwise deforming. In the examples of FIGS. 2 and 3, three retaining straps 72 are illustrated, but any number of retaining straps 72 can be provided. Further, in at least one example, the retaining straps 72 can be spaced equidistant from each other (as illustrated). In other examples, however, the retaining straps 72 need not be equidistant from each other, and can have a non-uniform spacing from adjacent retaining straps 72.

The retaining straps 72 are provided at the periphery 34 of the filter element 30 and can be adhered to the tip portion 42 of the pleats 36. In one example, the retaining straps 72 can also be adhered to at least one side (e.g., a first side 74 and a second side 75) of the pleats 36. The first side 74 and opposing second side 75 can, together, form the tip portion 42. The retaining straps 72 can include one or more extension portions 84 that extend at least partially into a region between adjacent pleats 36. The extension portions 84 can contact and/or adhere to the tip portion 42, first side 74 and second side 75 of the pleats 36. The extension portions 84 of the retaining straps 72 can limit the likelihood of adjacent pleats 36 from engaging each other and/or collapsing. Further, the retaining straps 72 can limit radial outward movement of the tip portions 42 to facilitate maintaining the pleats 36 at their pre-determined spacing during exposure to pressure and/or air flow.

The retaining straps 72 can include any number of materials. In one example, the retaining straps 72 can be formed from a melt-extrudable polymer material capable of withstanding a relatively high temperature operation (e.g., up to and/or exceeding 500° F/260° C.). The materials forming the retaining straps 72 can have sufficient strength and fatigue/chemical/temperature resistance to limit excessive radial movement of the filtration media 32 during operation. The retaining straps 72 can include, for example, melt-extrudable amorphous thermoplastic polyimide polymers, including blends or copolymers, of melt-extrudable amorphous thermoplastic polyimide polymers, and other high temperature polymers, for example, polyetherimides and polyether ether ketone (PEEK). In one example, the retaining straps 72 can include one or more of a thermoplastic polyurethane, a thermoplastic elastomer, a polyphenylsulfone (PPSU), a polysulfone (PSU), a polyether block amide, and/or a thermoplastic polyester elastomer.

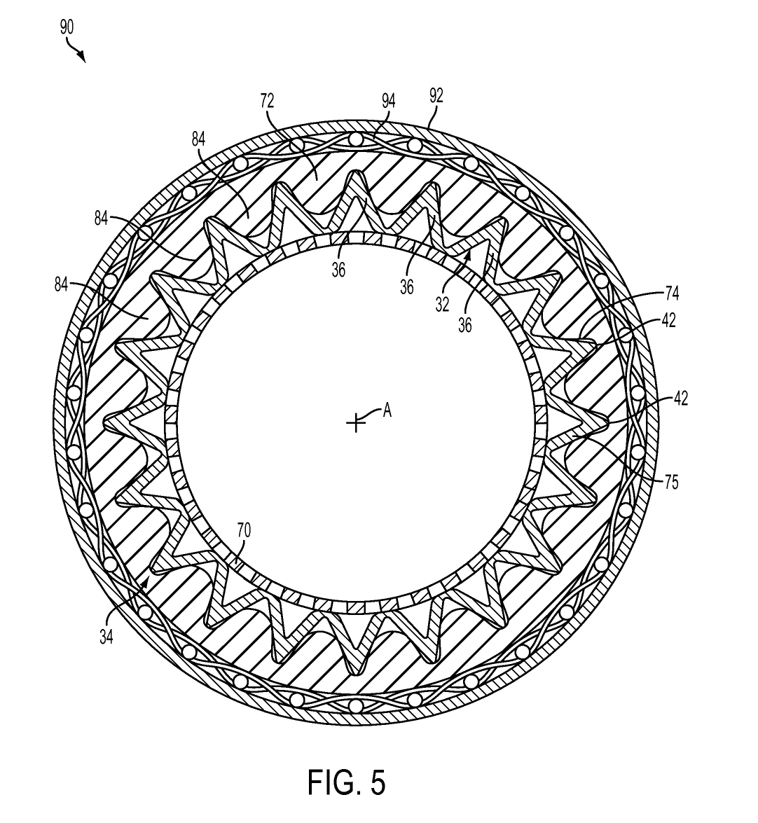

Turning now to FIG. 5, a sectional view of a second example filter element 90 is illustrated. In this example, the second filter element 90 is similar to the filter element 30 in that the second filter element 90 includes the filtration media 32 having pleats 36 with tip portions 42, along with the retaining strap 72. The filtration media 32, pleats 36, and retaining strap 72 are generally identical as described with respect to FIGS. 2 to 4, and need not be described in detail again.

The second filter element 90 includes a second retaining strap 92 in addition to the retaining strap 72. The second retaining strap 92 has a larger cross-sectional size (e.g., diameter) than the retaining strap 72, such that the second retaining strap 92 encompasses the retaining strap 72. The second retaining strap 92 can be similar or identical in material as the retaining strap 72, such that the second retaining strap 92 provides additional support to the filtration media 32.

The second retaining strap 92 can include a reinforcement structure 94. The reinforcement structure 94 can include any number of materials, including a woven glass fiber mat or other suitable textiles. The reinforcement structure 94 can be positioned radially between an outer surface of the retaining strap 72 and an inner surface of the second retaining strap 92. As such, the reinforcement structure 94 is positioned between the retaining strap 72 on one side and the second retaining strap 92 on an opposing second side. Together, the second retaining strap 92 and the reinforcement structure 94 can provide additional support to the filtration media 32 to limit unintended movement of the filtration media 32, pleats 36, or the like.

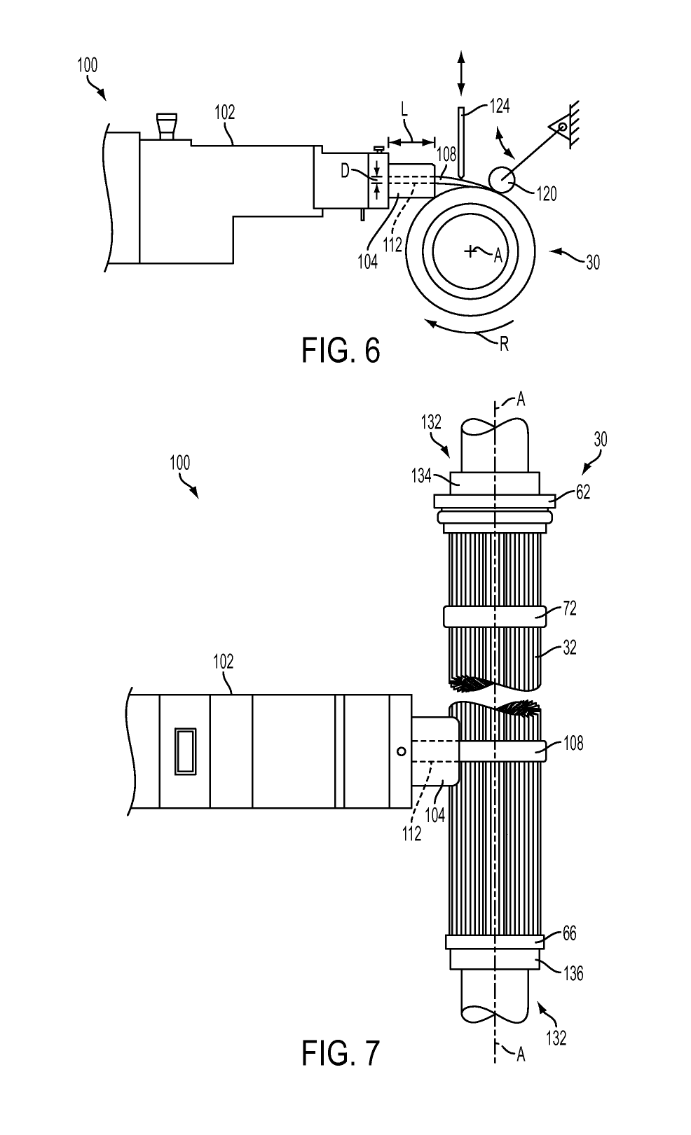

Turning now to FIG. 6, a schematic side view of an example application apparatus 100 is illustrated. The application apparatus 100 is illustrated somewhat generically/schematically for ease of illustration. Indeed, it is to be appreciated that the application apparatus 100 includes any number of structures/constructions, and is not limited to the example of FIG. 6. The application apparatus 100 can be used, for example, to apply the retaining strap 72 and the second retaining strap 92 to the filter elements 30, 90, respectively.

The application apparatus 100 can include an extruder 102. The extruder 102 includes a generally hollow interior portion through which a material can be pushed or drawn through. The extruder 102 is depicted generically/schematically, as it is to be understood that the extruder 102 includes any number of sizes, shapes, and constructions. In one example, the extruder 102 can accommodate hot, extrudable material such that the material is generally limited from hardening as the material passes through the extruder 102.

The extruder 102 can include an application barrel 104 positioned towards an end of the extruder 102. As with the extruder 102, the application barrel 104 is depicted generically/schematically, as the application barrel 104 includes any number of sizes, shapes, and constructions. In an example, a polymer extrudate 108 can flow through the application barrel 104 prior to exiting the application barrel 104 and being applied to the filter element 30.

The polymer extrudate 108 can flow through an extrusion flow channel 112 formed in the application barrel 104. The extrusion flow channel 112 is illustrated with dashed/broken lines in FIGS. 6 and 7 as the extrusion flow channel 112 is normally not visible in such a view. The extrusion flow channel 112 defines a generally hollow passageway extending entirely through the application barrel 104. In this example, the extrusion flow channel 112 has a generally circular cross-sectional shape, though other shapes are envisioned. As shown in FIG. 6, the extrusion flow channel 112 can have a length L and a hydraulic diameter D. It is to be appreciated that the length L and hydraulic diameter D of the extrusion flow channel 112 are not drawn to scale in either of FIGS. 6 and 7. In particular, the length L and hydraulic diameter D are somewhat enlarged for illustration purposes and to more clearly illustrate the location of the extrusion flow channel 112. In operation, however, the extrusion flow channel 112 can have a longer or shorter length L and/or a larger or smaller hydraulic diameter D than as illustrated.

By optimizing a ratio of length L to hydraulic diameter D of the extrusion flow channel 112, molecular orientation of the polymer extrudate 108 can be reduced. In general, extruding a polymer extrudate through an extrusion flow channel may impart a flow direction molecular orientation on the polymeric chains of the polymer extrudate. This molecular orientation can lock in internal stresses in the retaining strap when the polymer extrudate is cooled to form the retaining strap. As such, the retaining strap can be more brittle than desired, thus reducing the life of the retaining strap by increasing the likelihood of breaks, fractures, etc. in the retaining strap.

To optimize the length L to hydraulic diameter D ratio of the extrusion flow channel 112, experiments were carried out with extrusion flow channels 112 having varying length L to hydraulic diameter D ratios. Molecular orientation of polymeric chains within the polymer extrudate 108 is known to increase the tensile modulus of the polymer extrudate 108 in the direction of orientation. As such, the tensile modulus of the polymer extrudate 108 in the flow direction (e.g., direction along which the polymer extrudate 108 flows through the extrusion flow channel 112) was compared to the tensile modulus in a direction perpendicular to the flow direction to optimize the length L to hydraulic diameter D ratio of the extrusion flow channel 112. A material with a relatively high molecular orientation will have relatively large differences in tensile moduli in the two directions (e.g., flow direction compared to direction perpendicular to flow direction). A material with a relatively low molecular orientation will have a relatively low or nonexistent difference (e.g., independent of) in tensile moduli in the two directions (e.g., flow direction versus direction perpendicular to flow direction).

The results are displayed below in TABLE 1. Within the experiments, tensile modulus was measured using TA Instruments Q800 DMA (dynamic mechanical analyzer). Measurements were made at a temperature of approximately 68° F. (20° C.). Retaining straps 72 were extruded circumferentially around a 2 meter long filter element 30. Six equally spaced circumferential retaining straps 72 were extruded onto each filter element 30. The polymer extrudate 108 used was a thermoplastic polyester elastomer.

TABLE 1

| | Example A | Example B |
|---|---|---|
| Length to Hydraulic Diameter | 9.0 | 3.5 |
| ratio of extrusion flow channel | | |
| Tensile modulus of retaining | 1,636 MPa | 1,465 MPa |
| strap in flow direction of | | |
| polymer extrudate | | |
| Tensile modulus of retaining | 1,083 MPa | 1,275 MPa |
| strap in direction | | |
| perpendicular to flow | | |
| direction of polymer extrudate | | |
| Ratio of flow direction tensile | 1.51 | 1.15 |
| modulus to perpendicular | | |
| direction of tensile modulus | | |

The filter elements 30 of Example A and Example B were each dropped on their sides on a concrete floor from a height of approximately 2 meters (˜6.56 feet). Each of the six retaining straps 72 of the filter element 30 of Example A exhibited fracture. In contrast, none of the six retaining straps 72 of the filter element 30 of Example B exhibited any signs of fracture, cracking, breakage, or the like. Additional field testing in a simulated baghouse environment further demonstrated the benefits in terms of greater number of pulse cleaning cycles that the filter elements 30 of Example B can withstand before failure.

The results displayed in TABLE 1 illustrate that as the length L to hydraulic diameter D ratio of the extrusion flow channel 112 decreases, the ratio of flow direction tensile modulus to perpendicular direction of tensile modulus likewise decreases. In particular, referring to Example A, the length L to hydraulic diameter D ratio of the extrusion flow channel 112 was approximately 9.0. The retaining strap 72 produced by extruding the polymer extrudate 108 through this extrusion flow channel 112 had a tensile modulus in the flow direction of approximately 1,636 MPa (megapascals). The retaining strap 72 had a tensile modulus in the direction perpendicular to the flow direction of approximately 1,083 MPa. As such, the ratio of flow direction tensile modulus to perpendicular direction of tensile modulus was 1.51. This ratio, indicative of the differences in tensile moduli, suggested that the retaining strap 72 had a relatively high degree of molecular orientation. The subsequent drop tests in Example A, with all six retaining straps 72 exhibiting fracture, provide further proof of this relatively high degree of molecular orientation.

Referring now to Example B, the length L to hydraulic diameter D ratio of the extrusion flow channel 112 was approximately 3.5. The retaining strap 72 produced by extruding the polymer extrudate 108 through this extrusion flow channel 112 had a tensile modulus in the flow direction of approximately 1,465 MPa. The retaining strap 72 had a tensile modulus in the direction perpendicular to the flow direction of approximately 1,275 MPa. As such, the ratio of flow direction tensile modulus to perpendicular direction of tensile modulus was 1.15. This ratio suggested that the retaining strap 72 had a relatively low molecular orientation. In particular, the tensile moduli of the retaining strap 72 in the flow direction as compared to the perpendicular direction were generally independent of each other. The subsequent drop tests in Example B, with none of the retaining straps 72 exhibiting fracture, provide further proof of this relatively low/nonexistent degree of molecular orientation.

It is to be appreciated that the length L to hydraulic diameter D ratio of the extrusion flow channel is not limited to the aforementioned ratio. Rather, in other examples, different ratios can similarly provide the relatively low/nonexistent degree of molecular orientation. For instance, in one example, the retaining straps 72 can be extruded through the extrusion flow channel 112 having length L to hydraulic diameter D ratio of less than 6. In another example, the retaining straps 72 can be extruded through the extrusion flow channel 112 having length L to hydraulic diameter D ratio of less than 5.5. In yet another example, the retaining straps 72 can be extruded through the extrusion flow channel 112 having length L to hydraulic diameter D ratio of less than 5. In each of these examples, molecular orientation of the retaining straps 72 will remain relatively low.

The flow direction tensile modulus to perpendicular direction of tensile modulus is also not limited to the aforementioned ratio. Rather, in other examples, different ratios are indicative of the relatively low/nonexistent degree of molecular orientation, such that the lifespan of the filter elements 30 is improved. In one possible example, the at least one retaining strap 72 can have a ratio of flow direction tensile modulus to perpendicular direction tensile modulus of 1.5 or less. In another example, the at least one retaining strap 72 can have a ratio of flow direction tensile modulus to perpendicular direction tensile modulus of 1.2 or less. In yet another examples, the at least one retaining strap 72 can have a ratio of flow direction tensile modulus to perpendicular direction tensile modulus of 1.15 or less. In each of these examples, the retaining straps 72 have a relatively low molecular orientation, such that the lifespan of the filter elements 30 is increased.

In addition to optimizing the length to hydraulic diameter ratio of the extrusion flow channel 112, other features can be modified to further reduce and/or minimize molecular orientation of the retaining straps 72. In one example, a melt temperature of the polymer extrudate 108 can be varied, as a higher temperature of the polymer extrudate 108 reduces molecular orientation. In another example, a rate of cooling of the retaining strap 72 can be varied, as a slower rate of cooling reduces molecular orientation. In yet another example, a blending in of inorganic fillers into the polymer extrudate 108 can be provided to reduce molecular orientation. In still another example, a blend of multiple thermoplastic polymers can be used as the polymer extrudate 108 to reduce molecular orientation. In a further example, a higher molecular weight polymer can be used as the polymer extrudate 108 to reduce molecular orientation.

Referring still to FIG. 6, the filter element 30 can be positioned in proximity to the extruder 102. The polymer extrudate 108 can be applied circumferentially around the filtration media 32 of the filter element 30. In the illustrated example, the filter element 30 can be rotated about center axis A along rotation direction R. This rotation of the filter element 30 allows for the polymer extrudate 108 to be applied around the filter element 30. In other examples, however, the filter element 30 is not limited to being rotated about center axis A. Rather, the filter element 30 can remain fixed/stationary while the application apparatus 100 is rotated about the filter element 30.

The application apparatus 100 can include a roller 120. The roller 120 is illustrated somewhat generically/schematically as the roller 120 includes any number of constructions. In this example, the roller 120 is positioned in opposition to the extruder 102 and can be loaded with a pre-determined force such that the polymer extrudate 108 is biased/forced onto the filtration media 32 of the filter element 30. The roller 120 can force the polymer extrudate 108 into contact with the tip portion 42, first side 74, and second side 75 of the pleats 36 to engage and adhere to the filtration media 32.

The application apparatus 100 can include a cutoff mechanism 124. The cutoff mechanism 124, as with the roller 120, is illustrated generically/schematically as the cutoff mechanism 124 includes any number of constructions. In this example, the cutoff mechanism 124 is positioned between the extruder 102 and the roller 120 and can selectively cut/separate the polymer extrudate 108 at a desired time. The cutoff mechanism 124 is movable (i.e., indicated by double arrows) in a direction generally perpendicular to the direction along which the polymer extrudate 108 flows. After the polymer extrudate 108 has been applied to the filter element 30, the cutoff mechanism 124 can be moved (e.g., downwards towards the polymer extrudate 108) to cut and separate the polymer extrudate 108. The polymer extrudate 108 can be subsequently cooled to harden and form one of the retaining straps 72.

Turning now to FIG. 7, a schematic plan view of the filter element 30 and application apparatus 100 is illustrated. Again, it is to be appreciated that the extruder 102, and, in particular, the extrusion flow channel 112, is not drawn to scale for illustrative purposes. Indeed, the extruder 102 and extrusion flow channel 112 are depicted slightly larger in size than the example of FIG. 6 to more clearly show the structures of the application apparatus 100. In operation, however, the extrusion flow channel 112 of FIG. 7 will be of the same size (e.g., length L, diameter D, etc.) as the example depicted in FIG. 6.

The filter element 30 can be supported by a support mechanism 132. The support mechanism 132 can hold and rotate the filter element 30 during application of the retaining straps 72. The support mechanism 132 can include a mounting structure holder 134 and an end cap holder 136. The mounting structure holder 134 is sized to fit within and support mounting structure 62 of the filter element 30. The end cap holder 136 is sized to support the end cap 66 of filter element 20. The support mechanism 132 can position the filter element 30 such that longitudinal central axis A of the filter element 30 extends in a direction normal to the extrusion flow channel 112 of the application barrel 104. Either or both of the mounting structure holder 134 or end cap holder 136 can be rotatably coupled with a drive mechanism (not shown) to rotate the supported filter element 30 in proximity to the application barrel 104 of the extruder 102, along rotation direction R illustrated in FIG. 6.

Referring to FIGS. 6 and 7, an example operation of a method of fabricating the filter element 30 will now be described. Initially, the filtration media 32 can be provided in a tubular configuration. The filtration media 32 includes a plurality of circumferentially spaced apart pleats 36. Next, the polymer extrudate 108 can be extruded through the extrusion flow channel 112 of the extruder 102. As described above, the extrusion flow channel 112 can have a length L to hydraulic diameter D ratio of less than 6. In another example, the extrusion flow channel 112 can have a length L to hydraulic diameter D ratio of less than 5.5. In yet another example, the extrusion flow channel 112 can have a length L to hydraulic diameter D ratio of less than 5. Within each of these examples, the length L to hydraulic diameter D ratio of the extrusion flow channel 112 is sufficiently low enough so as to reduce/minimize molecular orientation within the retaining straps 72. This reduced molecular orientation will decrease the brittleness of the retaining straps 72, thus decreasing the likelihood of fractures, breaks, cracks, etc. within the retaining straps 72.

After the step of extrusion, the polymer extrudate 108 can be applied to the filter element 30. In particular, the polymer extrudate 108 can exit the extrusion flow channel 112 and is applied to extend circumferentially around a portion of the filtration media 32. Once applied to the filtration media 32, the polymer extrudate 108 can be cooled to form the retaining strap 72. The retaining strap 72 will extend circumferentially around the filtration media 32 to limit movement of the filtration media 32. In an example, the retaining strap 72 can limit axial, radial, and/or circumferential movement of the filtration media 32. In other examples, the retaining strap 72 can also limit/reduce the likelihood of adjacent pleats 36 from moving, collapsing, or otherwise deforming.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

1. A filter element including:
a filtration media formed into a tubular configuration and including a plurality of circumferentially spaced apart pleats; and
at least one retaining strap extending circumferentially around the filtration media to limit movement of the filtration media, the at least one retaining strap having a ratio of flow direction tensile modulus to perpendicular direction tensile modulus of 1.5 or less.

2. The filter element of claim 1, wherein the ratio of flow direction tensile modulus to perpendicular direction tensile modulus is 1.2 or less.

3. The filter element of claim 1, wherein the ratio of flow direction tensile modulus to perpendicular direction tensile modulus is 1.15 or less.

4. The filter element of claim 1, wherein the at least one retaining strap includes at least one of a thermoplastic polyurethane, thermoplastic elastomer, polyphenylsulfone (PPSU), polysulfone (PSU), polyether block amide, and thermoplastic polyester elastomer.

5. The filter element of claim 1, wherein each of the plurality of pleats includes a first side and an opposing second side forming a tip portion.

6. The filter element of claim 5, wherein the at least one retaining strap is attached to the tip portions of the plurality of pleats.

7. The filter element of claim 5, wherein the at least one retaining strap is attached to at least one of the first side and the second side.

8. The filter element of claim 5, wherein the at least one retaining strap includes an extension portion that extends between adjacent pleats.

9. The filter element of claim 1, wherein a tensile modulus of the at least one retaining strap along a flow direction is less than 1500 megapascals (MPa).

10. The filter element of claim 9, wherein a tensile modulus of the at least one retaining strap perpendicular to a flow direction is less than 1300 megapascals (MPa).

11. The filter element of claim 1, wherein the at least one retaining strap includes a polymer extrudate that is extruded through an extrusion flow channel having a length to hydraulic diameter ratio of less than 6.

12. The filter element of claim 11, wherein the extrusion flow channel has a length to hydraulic diameter ratio of less than 5.5.

13. The filter element of claim 11, wherein the extrusion flow channel has a length to hydraulic diameter ratio of less than 5.

14. A method of fabricating a filter element, the method including the steps of:
providing a filtration media formed into a tubular configuration and including a plurality of circumferentially spaced apart pleats;
extruding a polymer extrudate through an extrusion flow channel; and
applying the polymer extrudate to extend circumferentially around a portion of the filtration media to form a retaining strap that extends circumferentially around the filtration media to limit movement of the filtration media, the retaining strap having a ratio of flow direction tensile modulus to perpendicular direction tensile modulus of 1.5 or less.

15. The method of claim 14, wherein the extrusion flow channel has a length to hydraulic diameter ratio of less than 6.

16. The method of claim 14, wherein the extrusion flow channel has a length to hydraulic diameter ratio of less than 5.5.

17. The method of claim 14, wherein the extrusion flow channel has a length to hydraulic diameter ratio of less than 5.

18. The method of claim 14, wherein the retaining strap has a ratio of flow direction tensile modulus to perpendicular direction tensile modulus of 1.2 or less.

19. The method of claim 14, wherein the retaining strap has a ratio of flow direction tensile modulus to perpendicular direction tensile modulus of 1.15 or less.

20. The method of claim 14, wherein the retaining strap includes one of a thermoplastic polyurethane, thermoplastic elastomer, polyphenylsulfone (PPSU), polysulfone (PSU), polyether block amide, and thermoplastic polyester elastomer
